(19) United States
(12) Patent Application Publication
(10) Pub. No.: US 2020/0114424 A1
(43) Pub. Date: Apr. 16, 2020

(54) APPLICATION UNIT

(71) Applicant: CONCEPT LASER GMBH, Lichtenfels (DE)

(72) Inventors: Christoph SCHMIDBAUER, Neustadt bei Coburg (DE); Dagmar WOHLFARTH, Lichtenfels (DE); Christian DILLER, Lichtenfels (DE); Denise HIEMANN, Lichtenfels (DE); André PETRATSCHEK, Burgkunstadt (DE)

(73) Assignee: CONCEPT LASER GMBH, Lichtenfels (DE)

(21) Appl. No.: 16/294,053

(22) Filed: Mar. 6, 2019

(30) Foreign Application Priority Data
Oct. 10, 2018 (EP) 18199717.2

(51) Int. Cl. B22F 3/105; B29C 64/245; B29C 64/153

(52) U.S. Cl. CPC B22F 3/1055; B33Y 30/00; B29C 64/153; B29C 64/245

(57) ABSTRACT

Application unit (1) for applying, in particular powdery, build material in a build plane (2) in a process chamber (3) of an apparatus (4) for additively manufacturing three-dimensional objects, which application unit (1) comprises an application element (5) carried by an application element carrier (6), characterized in that the application element (5) is coupled to the application element carrier (6) via at least one deflection unit (9).

The invention relates to an application unit for applying, in particular powdery, build material in a build plane in a process chamber of an apparatus for additively manufacturing three-dimensional objects, which application unit comprises an application element carried by an application element carrier.

Application units for applying build material, in particular powdery build material, in a build plane of the process chamber of apparatuses for additively manufacturing three-dimensional objects are generally known from prior art. At least in powder bed based additive manufacturing processes, i.e. processes in which material is layerwise applied in a powder bed and selectively consolidated to form the three-dimensional object, application units are used to layerwise apply the build material. Known application units usually comprise an application element that is carried by an application element carrier, e.g. fixedly mounted on a frame-like structure. The application element may, inter alia, be built as a blade or a rake or the like that is adapted to convey build material and distribute the build material in the build plane.

For example, it is possible to use the application unit to convey build material from a dose plane in which the build material is provided to a build plane in which the build material is (evenly) distributed in advance to a consolidation process. Further, it is known from prior art that different application elements, in particular application elements built from different materials can be used dependent on the additive manufacturing process, e.g. dependent on the type of build material that is used. Inter alia, it is possible to use steel tools or flexible rubber profiles or carbon brushes dependent on the additive manufacturing process. However, the different application elements may lead to negative impacts on the additive manufacturing process.

For example, it is possible that fragments of carbon brushes or even complete carbon bristles are removed from the application element during an application process. Further, small parts of rubber from a rubber profile used as application element can be removed during an application process step that may contaminate the build material. On the other side, rigid tools, such as steel tools may apply pressure on a region of the object that protrudes the actual layer of build material leading to a contact between the application element and the object that may cause damage to the object and the application element, e.g. in damage to a filigree portion of the object.

It is an object of the present invention to provide an improved application unit, wherein in particular negative influences on the additive manufacturing process are reduced or avoided.

The object is inventively achieved by an application unit according to claim 1. Advantageous embodiments of the invention are subject to the dependent claims.

The application unit described herein is an application unit for an apparatus for additively manufacturing three-dimensional objects, e.g. technical components, by means of successive selective layerwise consolidation of layers of a powdered build material (“build material”) which can be consolidated by means of an energy source, e.g. an energy beam, in particular a laser beam or an electron beam. A respective build material can be a metal, ceramic or polymer powder. A respective energy beam can be a laser beam or an electron beam. A respective apparatus can be an apparatus in which an application of build material and a consolidation of build material is performed separately, such as a selective laser sintering apparatus, a selective laser melting apparatus or a selective electron beam melting apparatus, for instance. Alternatively, the successive layerwise selective consolidation of build material may be performed via at least one binding material. The binding material may be applied with a corresponding application unit and, for example, irradiated with a suitable energy source, e.g. a UV light source.

The apparatus may comprise a number of functional units which are used during its operation. Exemplary functional units are a process chamber, an irradiation device which is adapted to selectively irradiate a build material layer disposed in the process chamber with at least one energy beam, and a stream generating device which is adapted to generate a gaseous fluid stream at least partly streaming through the process chamber with given streaming properties, e.g. a given streaming profile, streaming velocity, etc. The gaseous fluid stream is capable of being charged with non-consolidated particulate build material, particularly smoke or smoke residues generated during operation of the apparatus, while streaming through the process chamber. The gaseous fluid stream is typically inert, i.e. typically a stream of an inert gas, e.g. argon, nitrogen, carbon dioxide, etc.

As described before, the invention relates to an application unit for applying build material in a build plane for an apparatus for additively manufacturing three-dimensional objects, wherein the application unit comprises an application element carried by an application element carrier. Typically, the application element is used for conveying or distributing the build material in the build plane. Hence, the application unit moves the build material thereby, transmitting or applying a force on the build material to distribute the build material (evenly) in the build plane, wherein the application element protrudes from the application element carrier towards the build plane. The invention is based on the idea that the application element is coupled to the application element carrier via at least one deflection unit.

The deflection unit allows for deflecting the application element relative to the application element carrier, i.e. generating a relative movement between the application element and the application element carrier. Thus, dependent on the force that is applied on the application element, the application element can be moved relative to the application element carrier. Hence, it is ensured that the application element does not negatively influence the additive manufacturing process, e.g. by applying a force on the object that is above a defined threshold value that would lead to a damage of filigree parts of the object. For example, if the application element comes in contact with the object, the application element may deflect, i.e. move relative to the application element carrier, thereby reducing the force that is applied on the object. Therefore, it is possible to avoid excessive forces on the build material, the application element and the object.

Hence, it is possible to use a solid or rigid material for the application element, such as steel, for instance, wherein the wear of the application element is significantly reduced and a cross-contamination with e.g. carbon bristles or rubber parts, i.e. foreign particles, is avoided. Thus, the tool life of the application element is significantly increased and the risk of contamination is reduced.

According to a preferred embodiment of the inventive apparatus, the deflection unit comprises a spring element. The spring element is used to mount the application element to the application element carrier, e.g. mounting the spring element between the application element carrier and the application element. Dependent on the force acting on the application element, the spring element may, for example, be compressed, wherein the application element is moved relative to the application element carrier, in particular the application element is deflected with respect to the application element carrier. The spring element may be chosen dependent on the specific additive manufacturing process that is performed and in which the application element or the application unit, respectively, is used for applying build material. For example, different spring elements with different spring rates or build from different materials can be used, e.g. dependent on the type of build material or the structure of the object.

The spring element may preferably be built as or comprise a spring and/or an elastically deformable element. The spring element may, for example, be built as a coil spring or the spring element may comprise at least two coil springs via which the application element is mounted on the application element carrier. Thus, dependent on the force acting on the application element the one or more coil springs can be compressed to allow for a relative movement of the application element relative to the application element carrier. On the other hand, the deflection unit, in particular the spring element, may spring load the application element against the application element carrier.

It is also possible that the spring element may be built as or may comprise an elastically deformable element, such as a rubber element e.g. a rubber pad, via which the application element may be mounted on the application element carrier, in particular the elastically deformable element may be arranged between the application element and the application element carrier.

As described before, the application element may be mounted to the application element carrier, wherein the deflection unit may be arranged between the application element and the application element carrier. It is particularly preferred that the application element is fastened against the application element carrier with the application unit acting as intermediate element. In other words, the application element may be mounted to the application element carrier, wherein the application element at least partially rests on the deflection unit. The deflection unit enables a movement of the application element relative to the application element carrier, e.g. in response to a force acting on the application element.

According to another preferred embodiment of the inventive apparatus, the application element is mounted to the application element carrier via a positive locking connection between the application element and the application element carrier, wherein the application element may be spring-loaded against the application element carrier, in particular via the deflection unit. According to this embodiment, a positive locking connection may be provided between the application element and the application element carrier. The deflection unit may load the application element against the application element carrier, wherein the deflection unit may be compressed or otherwise deformed under a force acting on the application element, e.g. an excessive force above a defined threshold value resulting from a part of the object protruding the plane on which build material has to be applied.

Hence, it is particularly preferred that the deflection unit is adapted to enable a deflection of the application element relative to the application element carrier), preferably for enabling at least one of
compensating a defect in the build plane, in particular a part of the object protruding from the build plane or an unevenness in the build plane
limiting a force acting on the application element
reducing wear of the application element
avoiding damaging the object.

Thus, when the application element is moved across the build plane to convey and distribute the build material, (excessive) forces can be compensated, as the application element may deflect relative to the application element carrier and therefore, may evade the part of the object, e.g. protruding a planar surface of the object. Therefore, if a contact between the application element and a part of the object occurs, the application element may deflect avoiding damage to the application element and/or the object.

The inventive application unit may further be improved in that the deflection unit may be adapted to enable a deflection of the application element for a deflection angle and/or a deflection height. Thus, it is possible that the application element may be deflected for a defined deflection angle and/or deflected for a defined deflection height compared to an initial position (application position) in which the application element is moved across the build plane in an application process. Therefore, the deflection unit provides a defined movement space in which the application element may be moved relative to the application element carrier, e.g. under force acting between application element and build material or object.

According to another preferred embodiment of the inventive application unit, the application element may be segmented. Hence, the application element may comprise at least two segments which two segments can be moved relative to one another and moved independently with respect to the application element carrier. Therefore, it is possible for the application element to locally react on different forces acting on the individual segments of the application element, wherein each segment or sub-element of the application element may be moved relative to the application element carrier, in particular each segment or sub-element may be deflected independently from the at least one other segment or sub-element. Therefore, it is not necessary to deflect the whole application element, if only one of the segments or sub-elements has contact with a part of the object or otherwise needs to be deflected from the initial position.

To segment the application element, it is possible that the application element is slotted or comprised of at least two application sub-elements, preferably between 5 and 100 mm wide. Thus, it is possible to only slot the application element, e.g. having a common part of the application element that connects the segments or sub-elements that can be moved relative to each other, e.g. individually deflected relative to the common part. Therefore, it is possible to provide at least one slot between the at least two segments that separates the at least two segments or sub-elements, respectively. It is also possible that the application element comprises multiple sub-elements that are, for example, individually coupled to the application element carrier, in particular individually mounted on the application element carrier. Therefore, in both approaches it is possible that the individual sub-elements may deflect with respect to the application element carrier. Additionally, a “second row” of application sub-elements can be arranged in parallel to the first set of application sub-elements. In particular, it is possible to arrange the second set of application sub-elements in that an application sub-element of the second set is arranged behind a slot between two application sub-elements of the first set of application sub-elements.

Regarding the embodiment comprising multiple individual sub-elements, it is also possible that not the entire application element is replaced or changed but it is possible to individually change the sub-elements as needed. For example, if only one of the sub-elements is worn, it is possible to merely change the worn sub-element and keep the at least one other sub-element.

Further, the application element may comprise at least one surface inclined with respect to a build plane and/or the application element carrier. During an application process, the application element with the at least one inclined surface may beneficially be moved with the inclined surface facing in application direction. Hence, the application element may be moved more smoothly over irregularities in the build plane, such as a bump or an unevenness. The inclined surface facing the application direction changes the contact angle under which the application element comes in contact with the build material in that conveying the build material and distributing the build material is further improved. Of course, the application element may also be moved with the inclined surface facing against application direction.

Preferably, the application element may comprise a hull-shaped cross-section. Thus, the cross-section of the application element may essentially be formed like the schematic hull of a ship with an inclined surface facing in application direction, for instance.

As described before, the application element may be built from different materials or comprise at least one portion build from a specific material, respectively. It is particularly preferred that the application element may comprise at least one portion build from a ceramic material and/or steel, preferably 1.2379 and/or 1.4301 and/or 1.4310, in particular a material related to the build material. Hence, the application element may be built from any arbitrary material, wherein, as described before, the application element may advantageously be built from a rigid material, as the deflection unit of the inventive application unit allows for a deflection, in particular a relative movement of the application element relative to the application element carrier. Thus, it is possible to use a rigid material, such as a ceramic or steel that allows for a long tool life and the possibility to precisely apply build material, as the application element itself does not deform during the application process.

It is particularly preferred that the application element is made from a material that is related to the build material, wherein preferably a new application element made from the same material that is used as build material is used in the additive manufacturing process. For example, if a metal powder is used as build material, the application element may be built from the same metal. Thus, a contamination of the build material with a different material can be avoided.

At least two of the application sub-elements that were described before can be built from the same material or from a different material. Thus, it is possible to choose the build material differently for the at least two different sub-elements, for example, if different regions of the build plane across which the application element is moved lead to a different wear behavior of the application element. For example, if a three-dimensional object is for the most part built in the center of the build plane, the central sub-elements of the application element can be built from a different material than application elements facing the edges of the build plane, for instance.

Besides, the invention relates to an apparatus for additively manufacturing three-dimensional objects by means of successive layerwise selective irradiation and consolidation of layers of a build material which can be consolidated by means of an energy source, which apparatus comprises an application unit, in particular an inventive application unit, as described before, which application unit comprises an application element carried by an application element carrier, wherein the application element is coupled to the application element carrier via at least one deflection unit.

Further, the invention relates to a method for operating an apparatus for additively manufacturing three-dimensional objects by means of successive layerwise selective irradiation and consolidation of layers of a build material which can be consolidated by means of an energy source, wherein at least one layer of build material is applied via an application unit, in particular an inventive application unit, as described before, comprising at least one application element that is coupled to an application element carrier via at least one deflection unit.

Of course, all features, details and advantages described with respect to the inventive application unit are fully transferable to the inventive apparatus and the inventive method.

Exemplary embodiments of the invention are described with reference to the Fig. The Fig. are schematic diagrams, wherein

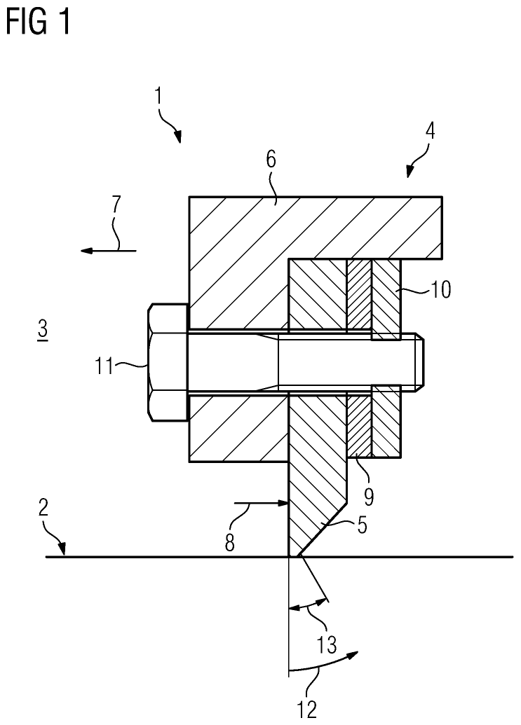

FIG. 1 shows an inventive application unit according to a first embodiment;

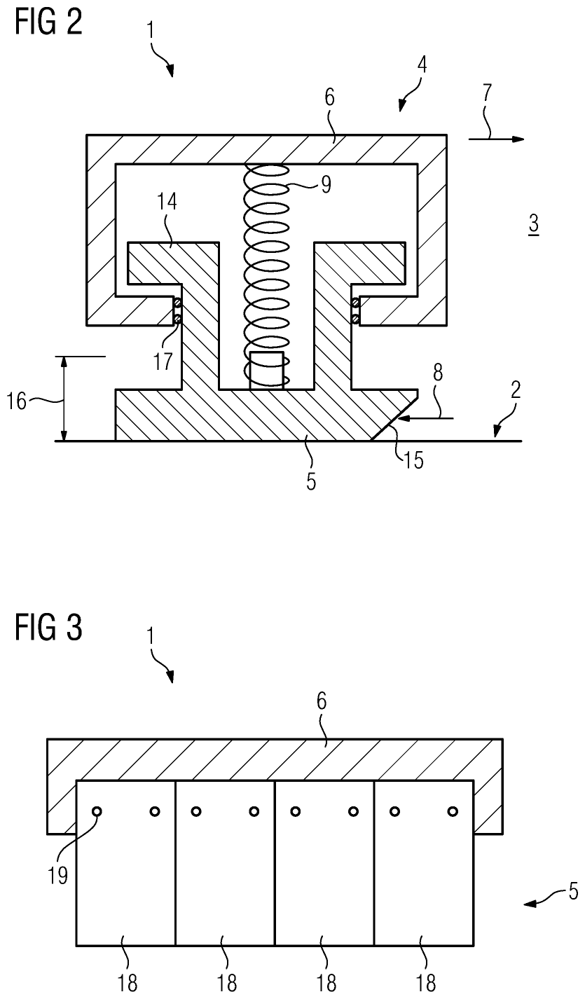

FIG. 2 shows an inventive application unit according to a second embodiment; and

FIG. 3 shows an application element of an inventive application unit.

FIG. 1 shows an application unit 1 for applying, in particular powdery, build material in the build plane 2 in a process chamber 3 of an apparatus 4 for additively manufacturing three-dimensional objects. The application unit 1 comprises an application element 5 carried by an application element carrier 6. The application element 5, of course, protrudes from the application element carrier 6 in that the application element 5 can contact build material to convey and distribute build material. To apply build material the application element 5 is moved across the build plane 2 in an application direction 7 for layerwise applying build material in the build plane 2, in particular conveying and distributing the build material in the build plane 2.

In the application process forces act on the application element 5 as exemplarily indicated via arrow 8. The application element 5 is mounted to the application element carrier 6 via a deflection unit 9 which is in this example built as an elastically deformable element, e.g. a rubber element. Of course, any other flexible or deformable material can be used to build the deflection unit 9, for example a spring. To fasten the application element 5 to the application element carrier 6, the application element carrier 6 comprises a fastening means 10, e.g. a (threaded) metal plate, and a fastening element 11 e.g. a screw, via which the application element 5 can be fastened to the application element carrier 6. As can be derived from FIG. 1, the deflection unit 9 forms an intermediate element between the application element carrier 6 and the application element 5 allowing for a movement of the application element 5 relative to the application element carrier 6.

In other words, if the force that acts/that is applied on the application element 5 in the direction that is indicated via arrow 8, the application element 5 may deflect and move relative to the application element carrier 6 out of the initial position that is depicted in FIG. 1 (as indicated via arrow 12). Hence, the application element 5 may be deflected for a deflection angle 13 out of the initial position that is depicted in FIG. 1. Thus, the deflection unit 9 allows that the application element 5 may avoid a contact with the object or irregularities in the build plane 2.

Hence, errors or irregularities in the build plane 2 can be compensated. Therefore, it is possible that a rigid application element 5 is used, e.g. an application element 5 made from ceramic or steel, wherein the tool life of the application element 5 is significantly increased compared to application elements made from rubber or carbon bristles or the like.

Advantageously, the application element 5 may be made from the same material, in particular metal, that is used as build material in the additive manufacturing process. Thus, a contamination of the build material with foreign material is avoided.

FIG. 2 shows an application unit 1 according to a second embodiment. The application unit 1 also comprises an application element 5 mounted on an application element carrier 6 which application element 5 can be moved across the build plane 2 for applying build material in the build plane 2, as described before. The application unit 1 depicted in FIG. 2 comprises an application element 5 and an application element carrier 6 that provide a positive locking connection, e.g. via connecting means 14. In this example, the application element 5 is loaded against the application element carrier 6, in particular spring-loaded, via the deflection unit 9.

Thus, the application element 5 is spring-loaded against the application element carrier 6 in the direction of the build plane 2. In other words, forces acting on the application element 5 it during the additive manufacturing process, in particular an application process of build material, act on an inclined surface 15 that faces in application direction 7. Therefore, the application element 5 is moved relative to the application element carrier 6 which movement, in particular which lateral movement is enabled by the deflection element 9, which may be, inter alia, built as spring, in particular coil spring. In other words, the application element 5 maybe deflected out of the initial position that is depicted in FIG. 2 for a defined deflection height, as indicated via arrow 16.

Therefore, (excessive) forces acting on the application element 5 lead to a relative movement between the application element 5 and the application element carrier 6 by compressing the deflection unit 9 and moving the application element 5 into the application element carrier 6. To avoid build material from entering the application element carrier 6 sealing elements 17 may be provided between the application element 5 and the application element carrier 6.

FIG. 3 shows an application element 5 for an inventive application unit 1, for example one of the application units 1 from FIG. 1, 2. The application element 5 is comprised of individual application sub-elements 18 that are individually mounted via a corresponding fastening means 19 to an application element carrier 6. Of course, it is also possible to provide a common application element 5 that is slotted into individual application segments or application sub-elements 18.

The individual application sub-elements 18 are individually moveable, in particular deflectable, relative to the application element carrier 6, as described before. The sub-elements 18 may individually be changed, e.g. loosened or attached to the application element carrier 6. For example, if one of the application sub-elements 18 is worn, it can individually be exchanged and the other application sub-elements 18 can remain in position. It is also possible that deviations in the build plane 2 that occur only locally are compensated by a relative movement of only one application sub-element 18 instead of deflecting the entire application element 5.

It is further possible that the individual application sub-elements 18 are made from the same or a different material. For example, application sub-elements 18 that are assigned to regions of the build plane 2 in which the wear on the application sub-elements 18 is higher, a different, in particular more rigid material can be used to increase the tool life.

Of course, all details, features and advantages described with respect to the individual embodiments can arbitrarily be exchanged, transferred and combined. Self-evidently, the inventive method may be performed on the inventive apparatus 4, preferably using an inventive application unit 1.

1. Application unit (1) for applying, in particular powdery, build material in a build plane (2) in a process chamber (3) of an apparatus (4) for additively manufacturing three-dimensional objects, which application unit (1) comprises an application element (5) carried by an application element carrier (6), characterized in that the application element (5) is coupled to the application element carrier (6) via at least one deflection unit (9).

2. Application unit according to claim 1, characterized in that the deflection unit (9) comprises a spring element.

3. Application unit according to claim 2, characterized in that the spring element is built as or comprises a spring and/or an elastically deformable element.

4. Application unit according to claim 1, characterized in that the application element (5) is fastened against the application element carrier (6) with the deflection unit (9) acting as intermediate element.

5. Application unit according to claim 1, characterized in that the application element (5) is mounted to the application element carrier (6) via a positive locking connection between the application element (5) and the application element carrier (6), wherein the application element (5) is spring loaded against the application element carrier (6).

6. Application unit according to claim 1, characterized in that the deflection unit (9) is adapted to enable a deflection of the application element (5) relative to the application element carrier (6), preferably for enabling at least one of
compensating a defect in the build plane (2), in particular a part of the object protruding from the build plane (2) or an unevenness in the build plane (2)
limiting a force acting on the application element (5)
reducing wear of the application element (5)
avoiding damaging the object.

7. Application unit according to claim 1, characterized in that the deflection unit (9) is adapted to enable a deflection of the application element (5) for a deflection angle (12) and/or a deflection height (16).

8. Application unit according to claim 1, characterized in that the application element (5) is segmented.

9. Application unit according to claim 1, characterized in that the application element (5) is slotted or comprised of at least two application sub-elements (18), preferably between 5 and 100 mm wide.

10. Application unit according to claim 1, characterized in that the at least two application sub-elements (18) are individually coupled to the application element carrier (6).

11. Application unit according to claim 1, characterized in that the application element (5) comprises at least one surface (15) inclined with respect to a build plane (2) and/or the application element carrier (6).

12. Application unit according to claim 1, characterized in that the application element (5) comprises a hull-shaped cross-section.

13. Application unit according to claim 1, characterized in that the application element (5) comprises at least one portion built from ceramic and/or steel, preferably 1.2379 and/or 1.4301 and/or 1.4310, in particular a material related to the build material.

14. Application unit according to claim 1, characterized in that at least two application sub-elements (18) are built from the same or different material.

15. Apparatus (4) for additively manufacturing three-dimensional objects by means of successive layerwise selective irradiation and consolidation of layers of a build material which can be consolidated by means of an energy source, which apparatus (4) comprises an application unit (1), in particular an application unit (1) according to claim 1, which application unit (1) comprises an application element (5) carried by an application element carrier (6), characterized in that the application element (5) is coupled to the application element carrier (6) via at least one deflection unit (9).

16. Method for operating an apparatus (4) for additively manufacturing three-dimensional objects by means of successive layerwise selective irradiation and consolidation of layers of a build material which can be consolidated by means of an energy source, characterized by applying at least one layer of build material via an application unit (1), in particular an application unit (1) according to claim 1, comprising at least one application element (5) that is coupled to an application element carrier (6) via at least one deflection unit (9).
